(19) United States
(12) Patent Application Publication
(10) Pub. No.: US 2023/0398990 A1
(43) Pub. Date: Dec. 14, 2023

(54) MOBILE BODY CONTROL DEVICE, MOBILE BODY CONTROL METHOD, AND STORAGE MEDIUM

(71) Applicant: HONDA MOTOR CO., LTD., Tokyo (JP)

(72) Inventors: Haruhiko Nishiguchi, Tokyo (JP); Hironori Aoyagi, Tokyo (JP)

(21) Appl. No.: 18/207,161

(22) Filed: Jun. 8, 2023

(30) Foreign Application Priority Data
Jun. 14, 2022 (JP) 2022-095988

(51) Int. Cl. B60W 30/18; B60W 50/14

(52) U.S. Cl. CPC B60W 30/18163; B60W 50/14; B60W 2552/10

(57) ABSTRACT

A mobile body control device includes a recognizer configured to recognize a surrounding environment of a mobile body, and a determiner configured to determine whether an object is present in a target area in which a direction along a traveling direction of the mobile body is set as a longitudinal direction on a side of the mobile body on the basis of a result of the recognition of the surrounding environment by the recognizer, and when it is determined that the object is present in the target area, to control a notifier to notify a driver of the mobile body to this effect, in which the determiner makes a width of the target area in a transverse direction when a lane change in which the mobile body changes a traveling lane has progressed to a predetermined stage smaller than the width in the transverse direction before the lane change progresses to the predetermined stage.

### CROSS-REFERENCE TO RELATED APPLICATION

Priority is claimed on Japanese Patent Application No. 2022-095988, filed Jun. 14, 2022, the content of which is incorporated herein by reference.

### BACKGROUND

### Field of the Invention

The present invention relates to a mobile body control device, a mobile body control method, and a storage medium.

### Description of Related Art

In recent years, efforts have been actively made to provide an access to sustainable transport systems in consideration of people in vulnerable positions among transport participants. In order to realize this, research and development to further improve the safety and convenience of traffic through research and development related to a driving assistance technology has been focused upon. In connection with such research, a technology of detecting and performing a notification of a cautionary vehicle when the vehicle changes lanes has been developed (Japanese Patent No. 4220699).

### SUMMARY

However, in conventional techniques, there may be a case in which a cautionary vehicle cannot be adequately detected.

The present invention has been made in consideration of such circumstances, and an object thereof is to provide a mobile body control device, a mobile body control method, and a storage medium capable of appropriately detecting a cautionary vehicle at the time of changing lanes. Thus, it will further contribute to the development of sustainable transportation systems.

The mobile body control device, the mobile body control method, and the storage medium according to the present invention have adopted the following configurations.
(1): A mobile body control device according to one aspect of the present invention includes a storage device that has stored a program, and a hardware processor, in which the hardware processor executes a program stored in the storage device, thereby recognizing a surrounding environment of a mobile body, determining whether an object is present in a target area in which a direction along a traveling direction of a mobile body is set as a longitudinal direction on a side of the mobile body on the basis of a result of the recognition of the surrounding environment, and when it is determined that an object is present in the target area, executing notification control that controls a notifier to notify a driver of the mobile body to this effect, and making a width of the target area in a transverse direction when a lane change in which the mobile body changes a traveling lane has progressed to a predetermined stage smaller than the width in the transverse direction before the lane change progresses to the predetermined stage in the notification control.
(2): In the aspect of (1) described above, the hardware processor sets the width of the target area in the transverse direction on the basis of a position of a traveling lane that is a change destination.
(3): In the aspect of any one of (1) and (2) described above, the hardware processor further executes lane change control for causing the mobile body to perform a lane change, the hardware processor does not notify of a presence of an object while curbing a start of the lane change control when it is determined that the object is present in the target area before the start of the lane change control, and the hardware processor notifies of the presence of the object while continuing to execute the lane change control when it is determined that the object is present in the target area after the start of the lane change control.
(4): In the aspect of any one of (1) and (2) described above, the hardware processor further executes lane change control for causing the mobile body to perform a lane change, the predetermined stage is a stage in which a specific part of the mobile body enters a traveling lane that is a change destination, and when it is determined that an object is in the target area at a stage in which the specific part is present in a traveling lane that is a change origin after the start of the lane change control, the hardware processor notifies of the presence of the object while curbing execution of the lane change control, and when it is determined that an object is present in the target area at a stage in which the specific part is present in a traveling lane that is a change destination after the start of the lane change control, the hardware processor notifies of the presence of the object while continuing to execute the lane change control.
(5): A mobile body control method according to another aspect of the present invention includes, by a computer mounted in a mobile body, recognizing a surrounding environment of the mobile body; determining whether an object is present in a target area in which a direction along a traveling direction of the mobile body is set as a longitudinal direction on a side of the mobile body on the basis of a result of the recognition of the surrounding environment; controlling a notifier to notify a driver of the mobile body to this effect when it is determined that the object is present in the target area; and making a width of the target area in a transverse direction when a lane change in which the mobile body changes a traveling lane has progressed to a predetermined stage smaller than the width in the transverse direction before the lane change progresses to the predetermined stage.
(6): A storage medium according to still another aspect of the present invention is a computer-readable non-transitory storage medium that has stored a program for causing a computer mounted in a mobile body to execute recognizing a surrounding environment of the mobile body, determining whether an object is present in a target area in which a direction along a traveling direction of the mobile body is set as a longitudinal direction on a side of the mobile body on the basis of a result of the recognition of the surrounding environment, controlling a notifier to notify a driver of the mobile body to this effect when it is determined that the object is present in the target area, and making a width of the target area in a transverse direction when a lane change in which the mobile body changes a traveling lane has progressed to a predetermined stage smaller than the width in the transverse direction before the lane change progresses to the predetermined stage.

According to the aspects of (1) to (6) described above, it is possible to appropriately detect a cautionary vehicle at the time of changing lanes.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram which shows an example of correspondences among a driving mode, a control state of a host vehicle, and a task.

FIG. 4 is a diagram which shows an outline of lane change control.

FIG. 5 is a diagram which shows an outline of a cautionary vehicle notification function in the embodiment.

FIG. 6 is a diagram which shows a first setting example of a target area at the time of changing lanes.

FIG. 7 is a diagram which shows a second setting example of the target area at the time of changing lanes.

FIG. 8 is a diagram showing an example of a situation in which a cautionary vehicle is detected more than necessary when the size of the target area is not changed at the time of changing lanes.

FIG. 9 is a diagram which shows a third setting example of the target area at the time of changing lanes.

FIG. 10 is a flowchart which shows an example of a flow of processing for realizing a cautionary vehicle notification function in the embodiment.

### DESCRIPTION OF EMBODIMENTS

Hereinafter, embodiments of a mobile body control device, a mobile body control method, and a storage medium of the present invention will be described with reference to the drawings. Here, an embodiment in which the mobile body is a vehicle will be described, but the present invention may also be applied to a mobile body other than a vehicle, which is a mobile body that travels on a lane specified for traveling and is configured so that part or all of the driving operations are automatically controlled (including lane change control).

[Overall Configuration]

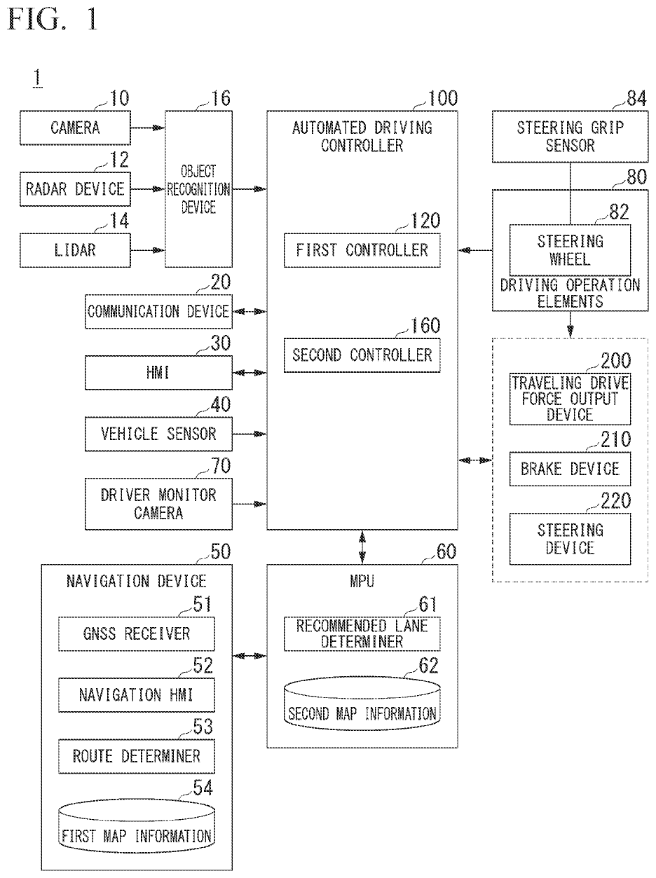

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operation elements 80, an automated driving controller 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added.

The camera 10 is a digital camera that uses a solid-state image sensor such as a charge coupled device (CCD) or a complementary metal oxide semiconductor (CMOS). The camera 10 is attached to an arbitrary place in a vehicle in which the vehicle system 1 is mounted (hereinafter, referred to as a host vehicle M). When an image of the front is captured, the camera 10 is attached to an upper part of the front windshield, a back surface of the windshield rear-view mirror, and the like. The camera 10 periodically and repeatedly captures, for example, a periphery of the host vehicle M. The camera 10 may be a stereo camera.

The radar device 12 radiates radio waves such as millimeter waves to the periphery of the host vehicle M, and also detects at least a position (a distance and an orientation) of an object by detecting radio waves (reflected waves) reflected by the object. The radar device 12 is attached to an arbitrary place on the host vehicle M. The radar device 12 may detect the position and speed of an object in a frequency modulated continuous wave (FM-CW) method.

The LIDAR 14 irradiates the periphery of the host vehicle M with light (or electromagnetic waves with wavelengths close to that of light) and measures scattered light. The LIDAR 14 detects a distance to a target on the basis of a time from light emission to light reception. The irradiated light is, for example, a pulsed laser beam. The LIDAR 14 is attached to an arbitrary place on the host vehicle M.

The object recognition device 16 performs sensor fusion processing on a result of detection by some or all of the camera 10, the radar device 12, and the LIDAR 14, and recognizes the position, type, speed, and the like of an object. The object recognition device 16 outputs a result of recognition to the automated driving controller 100. The object recognition device 16 may output the results of detection by the camera 10, the radar device 12, and the LIDAR 14 to the automated driving controller 100 as they are. The object recognition device 16 may be omitted from the vehicle system 1.

The communication device 20 communicates with other vehicles present in the periphery of the host vehicle M by using, for example, a cellular network, a Wi-Fi network, Bluetooth (a registered trademark), dedicated short range communication (DSRC), or the like, or communicates with various server devices via a wireless base station.

The HMI 30 presents various types of information to an occupant of the host vehicle M and receives an input operation by the occupant. The HMI 30 includes various display devices, a speaker, a buzzer, a touch panel, a switch, a key, and the like.

The vehicle sensor 40 includes a vehicle speed sensor that detects a speed of the host vehicle M, an acceleration sensor that detects acceleration, a yaw rate sensor that detects an angular speed around a vertical axis, an azimuth sensor that detects a direction of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M on the basis of a signal received from a GNSS satellite. The position of the host vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the host vehicle M identified (or an arbitrary position to be input) by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 on the basis of the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane from the left to drive. When a branch place is present on the route on a map, the recommended lane determiner 61 determines a recommended lane so that the host vehicle M can travel on a reasonable route to proceed to the branch destination.

The second map information 62 is map information with higher accuracy than the first map information 54. The second map information 62 includes, for example, information on a center of a lane, information on a boundary of the lane, and the like. In addition, the second map information 62 may include road information, traffic regulation information, address information (addresses/zip codes), facility information, telephone number information, information on a prohibited section in which a mode A or a mode B is prohibited, which will be described below, and the like. The second map information 62 may be updated at any time by the communication device 20 communicating with another device.

The driver monitor camera 70 is, for example, a digital camera using a solid-state imaging device such as CCD or CMOS. For example, the driver monitor camera 70 is attached at any place on the host vehicle M, which is a position and a direction at which the head of an occupant (hereafter referred to as a driver) seated in a driver's seat of the host vehicle M can be imaged from the front (in a direction for imaging the face). For example, the driver monitor camera 70 is attached to an upper portion of a display device provided in a center portion of an instrument panel of the host vehicle M.

The driving operation elements 80 includes, for example, in addition to the steering wheel 82, an accelerator pedal, a brake pedal, a shift lever, and other operation elements. The driving operation elements 80 has a sensor that detects the amount of operation or a presence or absence of an operation attached thereto, and a result of detection is output to the automated driving controller 100, or some or all of the traveling drive force output device 200, the brake device 210, and the steering device 220. The steering wheel 82 is an example of an “operation element that receives a steering operation from a driver.” The operation element does not necessarily have to be circular, and may be in a form of a deformed steering wheel, a joystick, a button, or the like. A steering grip sensor 84 is attached to the steering wheel 82. The steering grip sensor 84 is realized by an electrostatic capacitance sensor or the like, and outputs a signal capable of detecting whether the driver is gripping the steering wheel 82 (being in a contact in a state where force is applied) to the automated driving controller 100.

The automated driving controller 100 includes, for example, a first controller 120, and a second controller 160. The first controller 120 and the second controller 160 are realized by, for example, a hardware processor such as a central processing unit (CPU) executing a program (software), respectively. Some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as an HDD or flash memory of the automated driving controller 100, or may be stored in a detachable storage medium such as a DVD or a CD-ROM and installed in the HDD or flash memory of the automated driving controller 100 by the storage medium (non-transitory storage medium) being attached to a drive device. The automated driving controller 100 is an example of a “vehicle control device,” and a combination of the action plan generator 140 and the second controller 160 is an example of a “controller.”

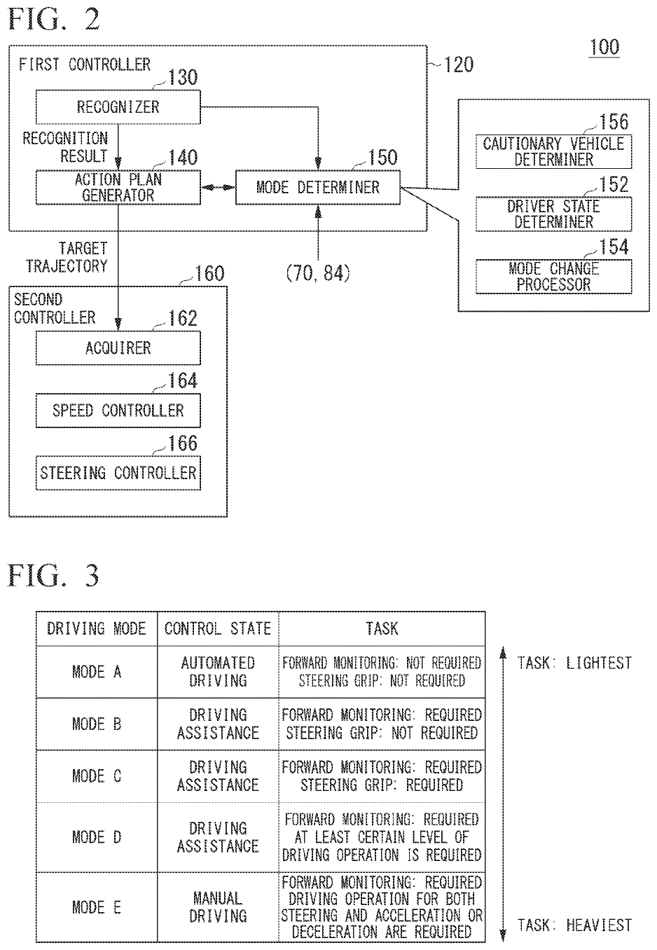

FIG. 2 is a functional configuration diagram of the first controller 120 and the second controller 160. The first controller 120 includes, for example, the recognizer 130, the action plan generator 140, and a mode determiner 150. The first controller 120 realizes, for example, a function by artificial intelligence (AI) and a function of a predetermined model in parallel. For example, a function of “recognizing an intersection” may be realized by executing both recognition of an intersection by deep learning and recognition based on a predetermined condition (a signal for pattern matching, a road sign, or the like) in parallel, and scoring and comprehensively evaluating both. As a result, reliability of automated driving is ensured.

The recognizer 130 recognizes the position of an object in the periphery of the host vehicle M and states such as a speed and acceleration thereof on the basis of information input from the camera 10, the radar device 12, and the LIDAR 14 via the object recognition device 16. The position of an object is recognized as, for example, a position on absolute coordinates with a representative point (a center of gravity, a center of a drive axis, or the like) of the host vehicle M as an origin, and is used for control. The position of an object may be represented by a representative point such as the center of gravity or a corner of the object, or may be represented by an area. The “states” of an object may include the acceleration or jerk of the object, or a “behavioral state” (for example, whether a lane is being changed or is about to be changed).

The recognizer 130 recognizes, for example, a lane (a traveling lane) in which the host vehicle M is traveling. For example, the recognizer 130 recognizes a traveling lane by comparing a pattern of road division lines (for example, an array of solid lines and broken lines) obtained from the second map information 62 with a pattern of road division line in the periphery of the host vehicle M recognized from an image captured by the camera 10. The recognizer 130 may also recognize a traveling lane by recognizing not only the road division line but also road boundaries including the road division line, a road shoulder, a curb, a median strip, a guardrail, and the like. In this recognition, the position of the host vehicle M acquired from the navigation device 50 and a result of processing by the INS may be taken into account. The recognizer 130 recognizes stop lines, obstacles, red lights, tollhouses, and other road events.

The recognizer 130 recognizes the position and posture of the host vehicle M with respect to a traveling lane when the traveling lane is recognized. The recognizer 130 may recognize, for example, a deviation of a reference point of the host vehicle M from a center of the lane and an angle of the host vehicle M, formed with respect to a line connecting along the center of the lane in the traveling direction, as a relative position and the posture of the host vehicle M with respect to the traveling lane. Instead, the recognizer 130 may recognize the position or the like of the reference point of the host vehicle M with respect to any side end (a road division line or road boundary) of the traveling lane as the relative position of the host vehicle M with respect to the traveling lane.

In principle, the action plan generator 140 causes travel in a recommended lane determined by the recommended lane determiner 61, and furthermore, generates a target trajectory on which the host vehicle M will automatically travel (regardless of an operation of a driver) in the future to be able to respond to the surroundings status of the host vehicle M. The target trajectory includes, for example, a speed element. For example, the target trajectory is expressed as a sequence of points (trajectory points) to be reached by the host vehicle M. The trajectory point is a point to be reached by the host vehicle M for each predetermined traveling distance (for example, about several [m]) along a road, and, separately, a target speed and a target acceleration for each predetermined sampling time (for example, about several tenths of a [sec]) are generated as a part of the target trajectory. The trajectory point may be a position to be reached by the host vehicle M at a corresponding sampling time for each predetermined sampling time. In this case, information on the target speed and target acceleration is expressed by an interval between trajectory points.

The action plan generator 140 may set an event of automated driving when a target trajectory is generated. The event of automated driving includes a constant-speed traveling event, a low-speed following traveling event, a lane change event, a branching event, a merging event, and a takeover event. The action plan generator 140 generates a target trajectory according to an event to be started.

The mode determiner 150 determines a driving mode of the host vehicle M between a plurality of driving modes with different tasks imposed on the driver. The mode determiner 150 includes, for example, a driver state determiner 152, a mode change processor 154, and a cautionary vehicle determiner 156. These individual functions will be described below.

FIG. 3 is a diagram which shows an example of correspondences among a driving mode, a control state of the host vehicle M, and a task. Driving modes of the host vehicle M include, for example, five modes, from a mode A to a mode E. The control state, that is, a degree of automation of the driving control, of the host vehicle M is the highest in the mode A, decreases in the order of the mode B, the mode C, and the mode D, and is the lowest in the mode E. On the other hand, the tasks imposed on the driver are the lightest in the mode A, increase in the order of the mode B, the mode C, and the mode D, and are the heaviest in the mode E. Since the control state is not automated driving in the modes D and E, a responsibility of the automated driving controller 100 is to end control related to automated driving and to shift to driving assistance or manual driving. Content of each driving mode will be exemplified below.

In the mode A, the state is automated driving, and the driver is tasked neither with monitoring in front nor with gripping the steering wheel 82 (steering grip in FIG. 3). However, even in the mode A, the driver is required to be in a posture that allows a quick shift to manual driving in response to a request from the system focusing on the automated driving controller 100. A term “automated driving” herein means that both the steering and the acceleration or deceleration are controlled regardless of an operation of the driver. The front is a space in the traveling direction of the host vehicle M visible through the front windshield. The mode A is, for example, a driving mode that can be executed when a condition is satisfied, such as that the host vehicle M is traveling at a predetermined speed (for example, about 50 [km/h]) or less on a dedicated road for automobiles such as a freeway and there is a preceding vehicle to follow, and it may also be referred to as Traffic Jam Pilot (TJP). The mode determiner 150 changes the driving mode of the host vehicle M to the mode B when this condition is no longer satisfied.

In the mode B, the state is driving assistance, and the driver is tasked with monitoring the front of the host vehicle M (hereinafter referred to as forward monitoring), but is not tasked with gripping the steering wheel 82. In the mode C, the state is driving assistance, and the driver is tasked with forward monitoring and gripping the steering wheel 82. The mode D is a driving mode in which a certain amount of driving operation by the driver is required for at least one of steering and acceleration or deceleration of the host vehicle M. For example, in the mode D, driving assistance such as adaptive cruise control (ACC) and a lane keeping assist system (LKAS) is performed. In the mode E, the vehicle is in a manual operation state in which the driver needs to perform a driving operation for both steering and acceleration or deceleration. In both of the modes D and E, the driver is naturally tasked with monitoring the front of the host vehicle M.

The automated driving controller 100 (and a driving assistance device (not shown)) performs an automatic lane change depending on the driving mode. An automatic lane change includes an automatic lane change (1) by a system request and an automatic lane change (2) by a driver request. The automatic lane change (1) includes an automatic lane change for passing which is performed when a speed of a preceding vehicle is lower than a speed of a host vehicle by a reference or more, and an automatic lane change for traveling toward a destination (automatic lane change due to change of a recommended lane). The automatic lane change (2) involves causing the host vehicle M to change lanes in a direction of operation when a direction indicator is operated by the driver when conditions of a speed and a positional relationship with surrounding vehicles are satisfied. Hereinafter, control for realizing an automatic lane change is referred to as lane change control.

The automated driving controller 100 executes neither of the automatic lane changes (1) and (2) in the mode A. In the modes B and C, the automated driving controller 100 executes both of the automatic lane changes (1) and (2). A driving assistance device (not shown) executes the automatic lane change (2) in the mode D without executing the automatic lane change (1). In the mode E, neither of the automatic lane changes (1) and (2) is executed.

The mode determiner 150 changes the driving mode of the host vehicle M to a driving mode with a heavier task when a task related to the determined driving mode (hereinafter, a current driving mode) is not executed by the driver.

For example, in the mode A, when the driver is in a posture that does not allow a shift to manual driving in response to a request from the system (for example, when the driver continues to look aside outside an allowable area, or when a sign indicating difficulty in driving is detected), the mode determiner 150 prompts the driver to shift to manual driving by using the HMI 30, and performs control such that the host vehicle M is gradually stopped while approaching a shoulder of a road, and automated driving is stopped if the driver does not respond. After the automated driving is stopped, the host vehicle is in a state of the mode D or E, and the host vehicle M can be started by a manual operation of the driver. In the following description, the same applies to “stopping automated driving.” When the driver is not monitoring the front in the mode B, the mode determiner 150 prompts the driver to monitor the front by using the HMI 30, and performs control such that the host vehicle M is brought closer to the shoulder of a road and gradually stopped, and the automated driving is stopped if the driver does not respond. When the driver does not monitor the front or does not grip the steering wheel 82 in the mode C, the mode determiner 150 prompts the driver to monitor the front and/or to grip the steering wheel 82 by using the HMI 30, and performs control such that the host vehicle M is brought closer to the shoulder of a road and gradually stopped, and the automated driving is stopped if the driver does not respond.

The driver state determiner 152 monitors a state of the driver for the mode change described above and determines whether the state of the driver is dependent on a task. For example, the driver state determiner 152 analyzes an image captured by a driver monitor camera 70 to perform posture estimation processing, and determines whether the driver is in a posture in which he or she cannot shift to manual driving in response to a request from the system. The driver state determiner 152 analyzes the image captured by the driver monitor camera 70 to perform line-of-sight estimation processing, and determines whether the driver is monitoring the front.

The mode change processor 154 performs various types of processing for a mode change. For example, the mode change processor 154 instructs the action plan generator 140 to generate a target trajectory for stopping on a road shoulder, instructs a driving assistance device (not shown) to operate, or performs control of the HMI 30 for prompting the driver to take action.

The cautionary vehicle determiner 156 determines whether other vehicles (cautionary vehicles) are present in a target area (to be described below) based on the host vehicle M. When the cautionary vehicle determiner 156 determines that a cautionary vehicle is present in the target area, it notifies a driver of the host vehicle M of that effect (a cautionary vehicle notification function). For example, the cautionary vehicle determiner 156 notifies of the presence of an object in a first notification mode or/and a second notification mode. The first notification mode is notification by a display and the second notification mode is notification with an alarm. For example, the first notification mode is a display of indicators (an example of various display devices) by the HMI 30. For example, the second notification mode is that the HMI 30 outputs an alarm sound through a speaker or a buzzer in addition to the display of indicators. The HMI 30 is an example of a “notifier.”

The automated driving controller 100 (and the driving assistance device (not shown), the same will be applied hereinafter) controls the execution of lane change control on the basis of a result of the detection of a cautionary vehicle by the cautionary vehicle determiner 156. For example, the automated driving controller 100 curbs a start of lane change control when it is determined that a cautionary vehicle is present in the target area before the start of lane change control. The automated driving controller 100 continues the execution of lane change control when it is determined that a cautionary vehicle is present in the target area after the start of lane change control. Here, “curbing the start of lane change control” may mean not starting lane change control, may mean canceling the start of scheduled lane change control, may mean delaying the start of scheduled lane change control, or may mean deferring the start of scheduled lane change control.

The automated driving controller 100 curbs the execution of lane change control when it is determined that a cautionary vehicle is present in the target area at a stage after the start of lane change control and before a lane change progresses to the predetermined stage. By curbing the execution of lane change control, it is possible to prevent a situation in advance in which a cautionary vehicle (an example of an object) and the host vehicle M (an example of a mobile body) come into contact with each other.

When it is determined that a cautionary vehicle is present in the target area at a timing after the start of lane change control and at which a lane change has progressed to a predetermined stage, the automated driving controller 100 continues the execution of lane change control, and notifies of the presence of a cautionary vehicle. This is because, when inertial force of the host vehicle M is directed to a traveling lane that is a change destination with the execution of lane change control, a behavior of the host vehicle M may be disturbed if the lane change control is interrupted and the host vehicle tries to return to an original traveling lane. For this reason, by continuing the execution of lane change control and notifying of the presence of a cautionary vehicle, it is possible to curb the disturbance of the behavior of the host vehicle M and further to eliminate or alleviate an anxiety and discomfort of the driver. In this case, it is possible to notify the driver of the presence of a cautionary vehicle while continuing the execution of lane change control, and thus both behavioral stability and safety of the host vehicle M can be achieved.

Here, curbing the execution of lane change control may mean suspending the lane change control which is being executed, may mean canceling the lane change control which is being executed, or may also mean preventing a lane change from progressing to a predetermined stage in the lane change control.

The second controller 160 controls the traveling drive force output device 200, the brake device 210, and the steering device 220 so that the host vehicle M passes through a target trajectory generated by the action plan generator 140 at a scheduled time.

Returning to FIG. 2, the second controller 160 includes, for example, an acquirer 162, a speed controller 164, and a steering controller 166. The acquirer 162 acquires information on a target trajectory (trajectory points) generated by the action plan generator 140 and stores it in a memory (not shown). The speed controller 164 controls the traveling drive force output device 200 or the brake device 210 on the basis of a speed element associated with the target trajectory stored in the memory. The steering controller 166 controls the steering device 220 according to a degree of bending of the target trajectory stored in the memory. Processing of the speed controller 164 and the steering controller 166 is realized by, for example, a combination of feedforward control and feedback control. As an example, the steering controller 166 executes feedforward control according to a curvature of a road in front of the host vehicle M and feedback control based on a deviation from the target trajectory in combination.

The traveling drive force output device 200 outputs a traveling drive force (torque) for the vehicle to travel to the drive wheels. The traveling drive force output device 200 includes, for example, a combination of an internal combustion engine, a motor, a transmission, and the like, and an electronic control unit (ECU) that controls these. The ECU controls the configuration described above according to information input from the second controller 160 or information input from the driving operation elements 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to the information input from the second controller 160 or the information input from the driving operation elements 80 so that a brake torque according to a braking operation is output to each wheel. The brake device 210 may include a mechanism for transmitting a hydraulic pressure generated by an operation of a brake pedal included in the driving operation elements 80 to the cylinder via a master cylinder as a backup. The brake device 210 is not limited to the configuration described above, and may be an electronically controlled hydraulic brake device that controls an actuator according to the information input from the second controller 160 to transmit the hydraulic pressure of the master cylinder to the cylinder.

The steering device 220 includes, for example, a steering ECU and an electric motor. The electric motor changes, for example, a direction of a steering wheel by applying a force to a rack and pinion mechanism. The steering ECU drives the electric motor according to the information input from the second controller 160 or the information input from the driving operation elements 80, and changes the direction of the steering wheel.

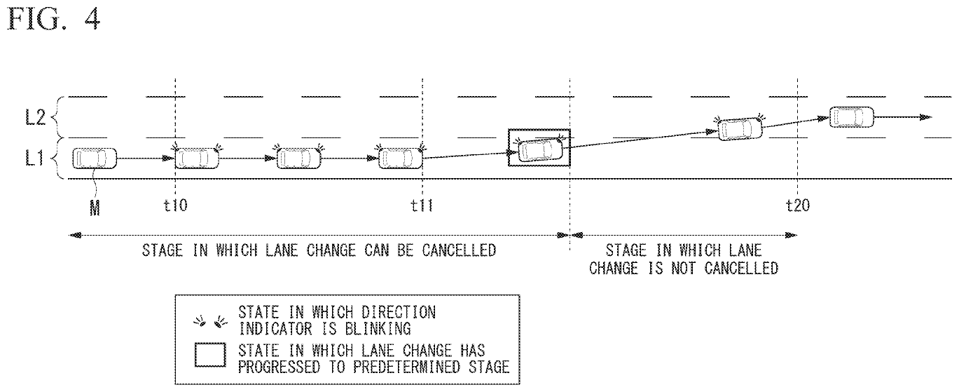

FIG. 4 is a diagram which shows an outline of lane change control. FIG. 4 shows how the host vehicle M changes the traveling lane from a first lane L1, which is a change origin, to a second lane L2, which is a change destination, by lane change control. FIG. 4 shows a situation in which the automated driving controller 100 has started lane change control at a time t10 and has ended the lane change control at a time t20 in response to a request of a system or an operation of the driver. A time t11 is a timing at which conditions for starting a lane change operation are satisfied after the lane change control is started. At this timing, the host vehicle M starts to move from the first lane L1 to the second lane L2, and as a result, the lane change is completed at the time t20. The lane change control ends in accordance with completion of the lane change.

In the lane change control, the automated driving controller 100 can cancel the lane change until the lane change progresses to a predetermined stage after the host vehicle M starts the lane change operation. On the other hand, in the lane change control, the automated driving controller 100 continues the lane change after the lane change has progressed to a predetermined stage after the host vehicle M starts the lane change operation. Cancellation of a lane change may be determined by an input of a canceling operation by the driver or by detection of a cautionary vehicle during the lane change.

Here, the predetermined stage of the lane change can be, for example, a stage in which an outer side of a front tire of the host vehicle M (an example of a “specific part”) comes into contact with an inner side of a boundary line between the first lane L1 and the second lane L2. A canceling operation can be, for example, the driver rotating the steering wheel 82 in a direction opposite to a direction of the lane change. When it is determined to cancel the lane change, the automated driving controller 100 controls an operation of the host vehicle M so that the host vehicle M continues traveling in the first lane L1.

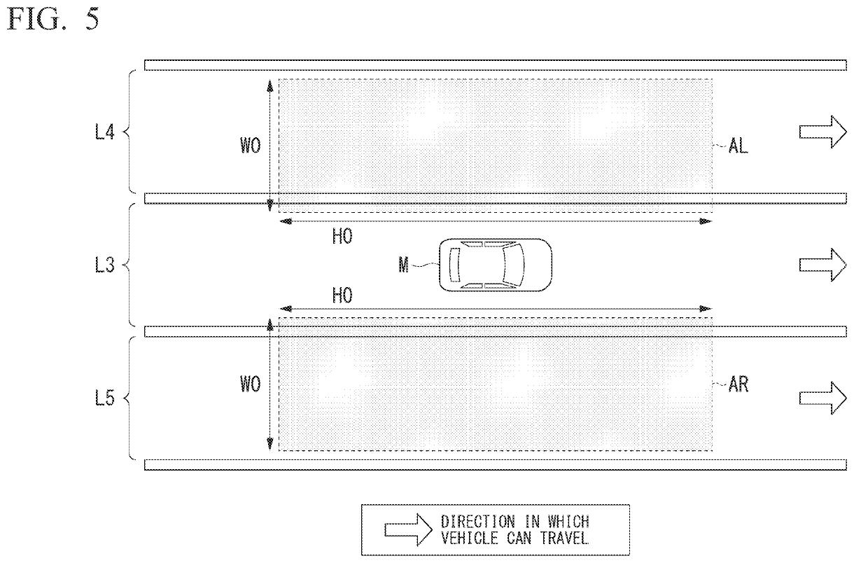

FIG. 5 is a diagram which shows an outline of the cautionary vehicle notification function in the embodiment. In FIG. 5, target areas AL and AR are areas in a range in which the cautionary vehicle determiner 156 detects a cautionary vehicle. Specifically, the target areas AL and AR are areas which are determined based on the position of the host vehicle M, and are areas in which a direction along the traveling direction of the host vehicle M is set as the longitudinal direction on a side of the host vehicle M. Here, as a simple example, a case where the target areas AL and AR are set as rectangular areas with a size of H0×W0 is shown. Here, H0 is a length of the target areas in a direction (a longitudinal direction) along the traveling direction of the host vehicle M, and W0 is a length thereof in a vehicle width direction (a transverse direction).

For example, the target areas AL and AR are set within a range in which other vehicles traveling near the host vehicle M can be detected in lanes L5 and L6 adjacent to a traveling lane L4 of the host vehicle M. The target areas AL and AR are basically set so that relative positions and ranges thereof with respect to the host vehicle M do not change. Here, this is because the cautionary vehicle determiner 156 of the present embodiment can basically set sizes of the target areas AL and AR variably according to a lane change situation of the host vehicle M as will be described below.

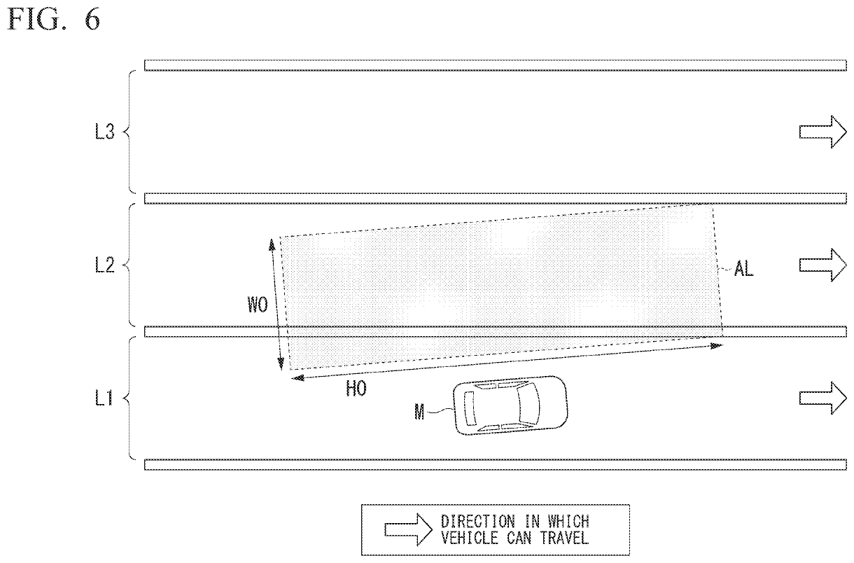

In the case of the example of FIG. 5, the cautionary vehicle determiner 156 determines whether a cautionary vehicle is present in the target areas AL and AR on the basis of a result of the recognition of the surrounding environment of the host vehicle M by the recognizer 130, and notifies the driver to this effect when it is determined that a cautionary vehicle is present in one or both of the target areas AL and AR. Basically, this operation may be always performed while the host vehicle M is traveling regardless of a driving mode of the host vehicle M. That is, the cautionary vehicle determiner 156 can detect a cautionary vehicle both when a lane change is performed by an operation of the driver and when a lane change is performed by a request of the system. With regard to such a cautionary vehicle notification function, the cautionary vehicle determiner 156 of the present embodiment sets the range of the target area according to a lane change state of the host vehicle M as described above. In the following description, FIGS. 6 to 8 show some setting examples of the target area.

FIG. 6 is a diagram which shows a first setting example of the target area at the time of changing lanes. FIG. 6 shows the target area AL set in a state immediately after the host vehicle M has started to change lanes from the first lane L1 in which it is traveling to the second lane L2 adjacent to a left side of the first lane L1. In this situation, since the lane change of the host vehicle M has not yet reached a predetermined stage, the cautionary vehicle determiner 156 sets the target area AL in the same range (a size of H0×W0) as normal.

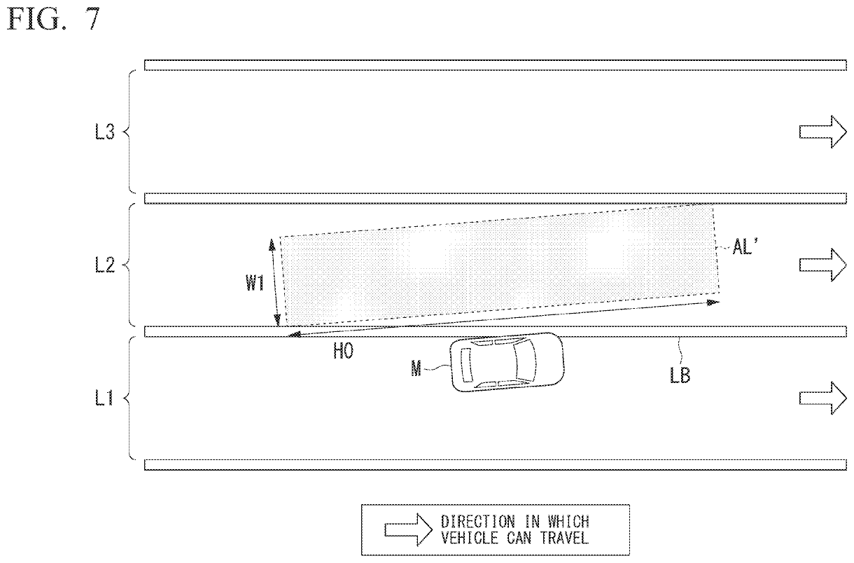

FIG. 7 is a diagram which shows a second setting example of the target area at the time of changing lanes. FIG. 7 shows a target area AL′ set in a situation in which the lane change has progressed to a predetermined stage after the host vehicle M has started to change lanes from the first lane L1 to the second lane L2. Here, as a predetermined stage of the lane change, a case in which the outer side of the front tire of the host vehicle M comes into contact with the inner side of the boundary line LB between the first lane L1 and the second lane L2 is exemplified. In this situation, the cautionary vehicle determiner 156 changes the previous target area AL to the target area AL′ in a range whose length in the vehicle width direction is shorter than normal (a size of H0×W1). That is, in this case, W0>W1.

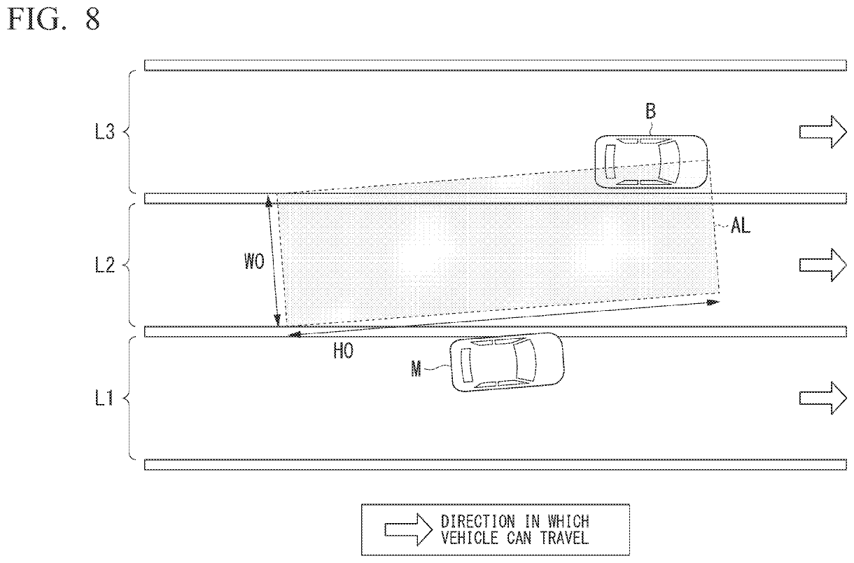

Such a size change is performed on the target area AL to avoid a situation in which, when the lane change of the host vehicle M has further progressed to a predetermined stage while keeping the target area in the same size as normal, the target area AL enters a third lane L3 adjacent to a further back side of the second lane L2 (for example, a situation in FIG. 8), and another vehicle (a vehicle B in an example of FIG. 8) traveling in the third lane L3 is detected as a cautionary vehicle. When such a size change is not performed, an unnecessary notification will be performed at the time of changing lanes, which may annoy the driver. On the other hand, the cautionary vehicle determiner 156 sets the target area AL′ that does not enter the third lane L3 in a situation after the lane change has progressed to a predetermined stage as shown in FIG. 7, and thereby it is possible to curb an unnecessary notification from being performed at the time of changing lanes.

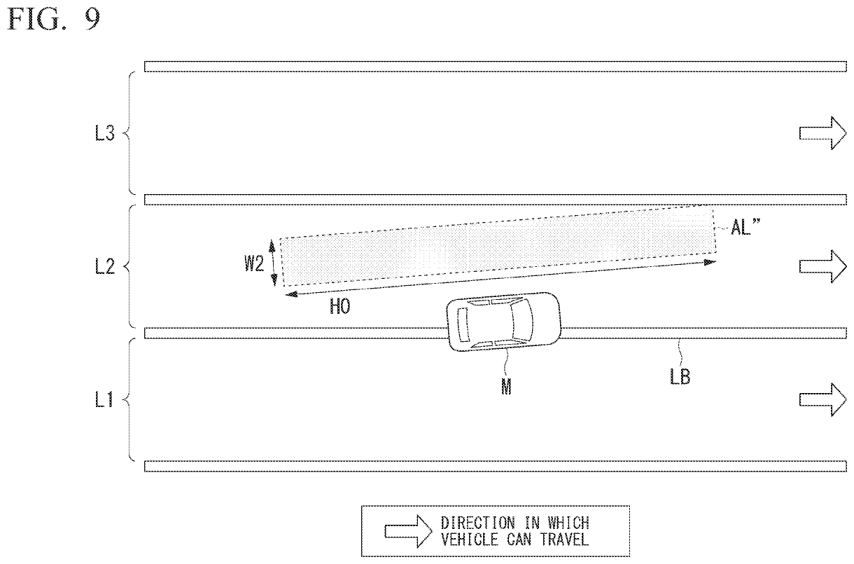

FIG. 9 is a diagram which shows a third setting example of the target area at the time of changing lanes. FIG. 9 shows a target area AL″ set at a stage in which more portions of a vehicle body have entered the second lane L2 after passing through a predetermined stage after the host vehicle M starts to change lanes from the first lane L1 to the second lane L2. In this case, since the host vehicle M has further approached the third lane L3, the cautionary vehicle determiner 156 sets the target area on a side in the lane change direction as the target area AL″ in a range (a size of H0×W2) whose length in the vehicle width direction is even shorter than in the case of FIG. 7. That is, in this case, W0>W1>W2.

In this manner, the cautionary vehicle determiner 156 sets a width of the target area in the vehicle width direction on the basis of a position of the traveling lane that is a change destination, and thereby it is possible to curb an unnecessary notification from being performed between a start and an end of a lane change.

FIGS. 6 to 9 show only the target areas (AL, AL′, AL″) on the side in the lane change direction, but the cautionary vehicle determiner 156 may set a target area on an opposite side of the lane change direction at the time of changing lanes. In this case, the target area on the opposite side of the lane change direction may be set to the same size as normal at the time of changing lanes.

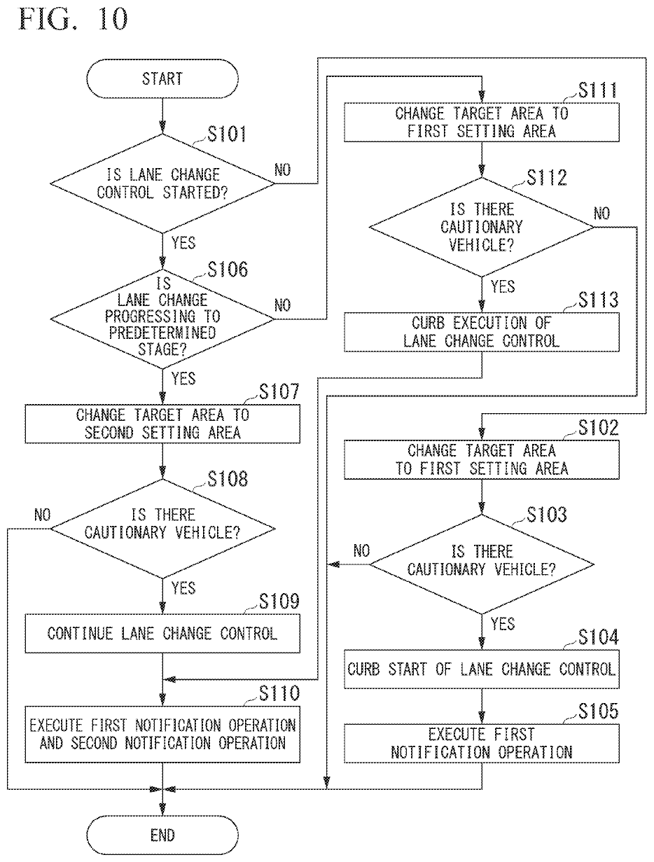

FIG. 10 is a flowchart which shows an example of a flow of processing for realizing the cautionary vehicle notification function in the embodiment. First, the cautionary vehicle determiner 156 determines whether lane change control has been started for the host vehicle M (step S101). Here, when it is determined that lane change control has not been started for the host vehicle M, the cautionary vehicle determiner 156 changes the target area to a first setting area (step S102). The first setting area is a target area that needs to be set normally. For example, the target area AL in FIGS. 6 to 9 is an example of the first setting area. When the first setting area has already been set as a target area, step S102 may be omitted.

Subsequently, the cautionary vehicle determiner 156 determines whether a cautionary vehicle is present in the first setting area (step S103). Here, when it is determined that a cautionary vehicle is not present in the first setting area, the cautionary vehicle determiner 156 ends a series of processing without performing notification of a cautionary vehicle. On the other hand, when it is determined in step S103 that a cautionary vehicle is present in the first setting area, the action plan generator 140 curbs a start of lane change control (step S104), and the cautionary vehicle determiner 156 executes first notification processing for a presence of the cautionary vehicle (step S105). The first notification processing is processing of notifying of the presence of a cautionary vehicle in a first notification mode (display, or the like).

On the other hand, when it is determined in step S101 that lane change control has been started for the host vehicle M, the cautionary vehicle determiner 156 determines whether a lane change of the host vehicle M has progressed to a predetermined stage (step S106). Specifically, the cautionary vehicle determiner 156 can recognize a stage of the lane change on the basis of a position of a lane recognized by the recognizer 130 and a position of the host vehicle M. Here, when it is determined that the lane change of the host vehicle M has progressed to the predetermined stage, the cautionary vehicle determiner 156 changes the target area to the second setting area (step S107).

The second setting area is a variable target area that is set on the basis of the position of the host vehicle M and the position of a lane that is a change destination at the time of changing lanes. For example, the target areas AL′ and AL″ in FIGS. 6 to 9 are examples of the second setting area. When the second setting area has already been set as the target area, step S107 may be omitted.

Subsequently, the cautionary vehicle determiner 156 determines whether a cautionary vehicle is present in the second setting area (step S108). Here, when it is determined that a cautionary vehicle is not present in the second setting area, the cautionary vehicle determiner 156 ends the series of processing without performing notification of a cautionary vehicle. On the other hand, when it is determined in step S108 that a cautionary vehicle is present in the second setting area, the action plan generator 140 continues to execute lane change control (step S109), and the cautionary vehicle determiner 156 executes the first notification processing and second notification processing for the presence of the cautionary vehicle (step S110). The second notification processing is processing of notifying of the presence of a cautionary vehicle in a second notification mode (an alarm, or the like).

On the other hand, when it is determined in step S106 that the lane change of the host vehicle M has not progressed to the predetermined stage, the cautionary vehicle determiner 156 changes the target area to the first setting area (step S111). Subsequently, the cautionary vehicle determiner 156 determines whether a cautionary vehicle is present in the first setting area (step S112). Here, when it is determined that a cautionary vehicle is not present in the first setting area, the cautionary vehicle determiner 156 ends the series of processing without performing notification of a cautionary vehicle.

On the other hand, when it is determined in step S112 that a cautionary vehicle is present in the first setting area, the action plan generator 140 curbs execution of the lane change control (step S113), and the cautionary vehicle determiner 156 executes the first notification processing and the second notification processing for the presence of the cautionary vehicle (step S110). By executing the processing described above for the cautionary vehicle notification function, it is possible to curb an unnecessary notification from being performed between the start and the end of the lane change of the host vehicle M.

Here, a case in which the lane change of the host vehicle M is performed by lane change control has been described, but the cautionary vehicle notification function of the embodiment can also be applied to a case in which the lane change is performed by a manual operation of the driver. In this case, the cautionary vehicle notification function recognizes, for example, the presence or absence of a lane change by a manual operation according to a blinking state of the direction indicator, and can be realized by omitting, for example, steps S101, S104, S109, and S113 related to lane change control in the flowchart of FIG. 10.

According to the automated driving controller 100 of the embodiment described above, the recognizer 130 that recognizes a surrounding environment of the host vehicle M (an example of the mobile body), and the cautionary vehicle determiner 156 that determines whether a cautionary vehicle (an example of the object) is present in a target area in which a direction along the traveling direction of the host vehicle M is set as a longitudinal direction on a side of the host vehicle M on the basis of a result of the recognition of the surrounding environment of the host vehicle M by the recognizer 130, and when it is determined that a cautionary vehicle is present in the target area, controls the HMI 30 (an example of the notifier) so that it notifies the driver of the host vehicle M to this effect are provided, and the cautionary vehicle determiner 156 makes a width of the target area in the transverse direction when a lane change (an example of the lane change) of the host vehicle M has progressed to a predetermined stage smaller than the width in the transverse direction before the lane change has progressed to the predetermined stage, and thereby it is possible to detect a cautionary vehicle more appropriately at the time of changing lanes.

That is, since a target area after a lane change is executed becomes narrower or smaller than a target area before the lane change is executed, it is possible to detect and notify of a cautionary vehicle in a wider or larger target area before the lane change is executed, and thereby the safety of the host vehicle M can be ensured, and a cautionary vehicle can be detected and notified in the narrower or smaller target area after the lane change is executed, and thereby it is possible to prevent a situation in which an unnecessary notification is performed due to the detection of a cautionary vehicle present in a lane other than a change destination lane to annoy the driver.

Although a mode for carrying out the present invention has been described above using the embodiment, the present invention is not limited to the embodiment, and various modifications and substitutions can be made in a range not departing from the gist of the present invention.

What is claimed is:

1. A mobile body control device comprising:
a storage device that has stored a program, and
a hardware processor,
wherein the hardware processor executes a program stored in the storage device, thereby
recognizing a surrounding environment of a mobile body,
determining whether an object is present in a target area in which a direction along a traveling direction of a mobile body is set as a longitudinal direction on a side of the mobile body on the basis of a result of the recognition of the surrounding environment, and when it is determined that an object is present in the target area, executing notification control that controls a notifier to notify a driver of the mobile body to this effect, and
making a width of the target area in a transverse direction when a lane change in which the mobile body changes a traveling lane has progressed to a predetermined stage smaller than the width in the transverse direction before the lane change progresses to the predetermined stage in the notification control.

2. The mobile body control device according to claim 1,
wherein the hardware processor sets the width of the target area in the transverse direction on the basis of a position of a traveling lane that is a change destination.

3. The mobile body control device according to claim 1,
wherein the hardware processor further executes lane change control for causing the mobile body to perform a lane change,
the hardware processor does not notify of a presence of an object while curbing a start of the lane change control when it is determined that the object is present in the target area before the start of the lane change control, and
the hardware processor notifies of the presence of the object while continuing to execute the lane change control when it is determined that the object is present in the target area after the start of the lane change control.

4. The mobile body control device according to claim 1,
wherein the hardware processor further executes lane change control for causing the mobile body to perform a lane change,
the predetermined stage is a stage in which a specific part of the mobile body enters a traveling lane that is a change destination, and when it is determined that an object is in the target area at a stage in which the specific part is present in a traveling lane that is a change origin after the start of the lane change control,
the hardware processor notifies of the presence of the object while curbing execution of the lane change control, and
when it is determined that an object is present in the target area at a stage in which the specific part is present in a traveling lane that is a change destination after the start of the lane change control,
the hardware processor notifies of the presence of the object while continuing to execute the lane change control.

5. A mobile body control method comprising:
by a computer mounted in a mobile body,
recognizing a surrounding environment of the mobile body;
determining whether an object is present in a target area in which a direction along a traveling direction of the mobile body is set as a longitudinal direction on a side of the mobile body on the basis of a result of the recognition of the surrounding environment;
controlling a notifier to notify a driver of the mobile body to this effect when it is determined that the object is present in the target area; and
making a width of the target area in a transverse direction when a lane change in which the mobile body changes a traveling lane has progressed to a predetermined stage smaller than the width in the transverse direction before the lane change progresses to the predetermined stage.

6. A computer-readable non-transitory storage medium that has stored a program for causing a computer mounted in a mobile body to execute
recognizing a surrounding environment of the mobile body,
determining whether an object is present in a target area in which a direction along a traveling direction of the mobile body is set as a longitudinal direction on a side of the mobile body on the basis of a result of the recognition of the surrounding environment,
controlling a notifier to notify a driver of the mobile body to this effect when it is determined that the object is present in the target area, and
making a width of the target area in a transverse direction when a lane change in which the mobile body changes a traveling lane has progressed to a predetermined stage smaller than the width in the transverse direction before the lane change progresses to the predetermined stage.
